(19) United States
(12) Patent Application Publication
(10) Pub. No.: US 2010/0133402 A1
(43) Pub. Date: Jun. 3, 2010

(54) VISUAL DISPLAY UNIT MOUNT

(76) Inventor: Jason Stebbens, Brighouse Yorkshire (GB)

Correspondence Address: MICHAEL BEST & FRIEDRICH LLP, 100 E WISCONSIN AVENUE, Suite 3300, MILWAUKEE, WI, 53202, US

(21) Appl. No.: 12/447,602

(22) PCT Filed: Oct. 25, 2007
(86) PCT No.: PCT/GB07/50655

§ 371 Date: Feb. 5, 2010

(30) Foreign Application Priority Data
Oct. 28, 2006 (GB) 0621489.4

(51) Int. Cl. F16M 13/02

(52) U.S. Cl. 248/287.1; 248/276.1

(57) ABSTRACT

The present invention provides an apparatus (1) for mounting a visual display unit (VDU) upon a structure, comprising: a support mounting member (10) for attaching to a structure; at least one support member (31,32) moveably mounted upon the mounting member; and at least one VDU mount (41a,41b,42a,42b) for mounting a VDU thereon, the VDU mount (41a,41b,42a,42b) being moveably mounted upon the support member (31,32) to be moveable in an upward and downward direction; wherein the support member (31,32) is moveably mounted upon the mounting member to be moveable in a direction generally transverse to the upward and downward direction.

The present invention relates to an apparatus and method for mounting a visual display unit (VDU) upon a supporting structure. In particular, although not exclusively, the present invention relates to the mounting of a flat panel VDU upon a support structure.

It is frequently desired to mount a visual display unit upon a supporting structure in order to provide a conveniently mounted visual display unit. For example, in a home it is common for VDU such as televisions to be mounted upon a wall to avoid a necessity to have a dedicated floor-stand provided for the television. To aid this, many televisions are provided with mounting points in a rearward area or region of an external case. The mounting points may be, for example, blind threaded apertures in a casing of the television arranged to receive appropriate fixing bolts.

A problem arises in that different VDU such as televisions typically have differently configured mounting points. For example, televisions from different manufacturers may have mounting points with a greater distance between centres. Alternatively, televisions from the same manufacturer which are of a different size may have differently spaced mounting points. Therefore, a user must purchase a television mounting bracket suitable for each individual television and, if the user changes televisions, the mounting bracket must also be changed appropriately.

Another problem arises in that as visual display units, such as televisions, become larger, and larger visual display units become cheaper, it is frequently desired to mount a large visual display unit upon a structure. This generally requires the use of a more heavily constructed mounting bracket, which is expensive.

It is an aim of the present invention to provide an apparatus and method for mounting a visual display unit upon a structure which overcomes the above-mentioned problems.

It is an aim of the present invention to provide an apparatus and method for mounting a visual display unit upon a structure which is adjustable for visual display units having differently configured or arranged mounting points.

It is an object of the present invention to provide an apparatus and method for mounting a visual display unit upon a structure which has a greater strength and/or is more rigidly constructed.

According to the present invention there is provided an apparatus and method as set forth in the appended claims. Other features of the invention will be apparent from the dependent claims, and the description which follows.

According to a first aspect of the present invention there is provided an apparatus for mounting a visual display unit (VDU) upon a structure, comprising: a support mounting member for attaching to a structure; at least one support member moveably mounted upon the mounting member; and at least one VDU mount for mounting a VDU thereon, the VDU mount being moveably mounted upon the support member to be moveable in an upward and downward direction; wherein the support member is moveably mounted upon the mounting member to be moveable in a direction generally transverse to the upward and downward direction.

According to a second aspect of the present invention there is provided A method of mounting a VDU upon a support structure, comprising: moving at least one VDU mount for mounting a VDU thereon in an upward and downward direction along a support member; moving the support member upon a support mounting member in a direction generally transverse to the upward and downward direction; mounting the VDU upon the at least one VDU mount; and mounting the support mounting member upon a structure.

For a better understanding of the invention, and to show how embodiments of the same may be carried into effect, reference will now be made, by way of example, to the accompanying diagrammatic drawings in which:

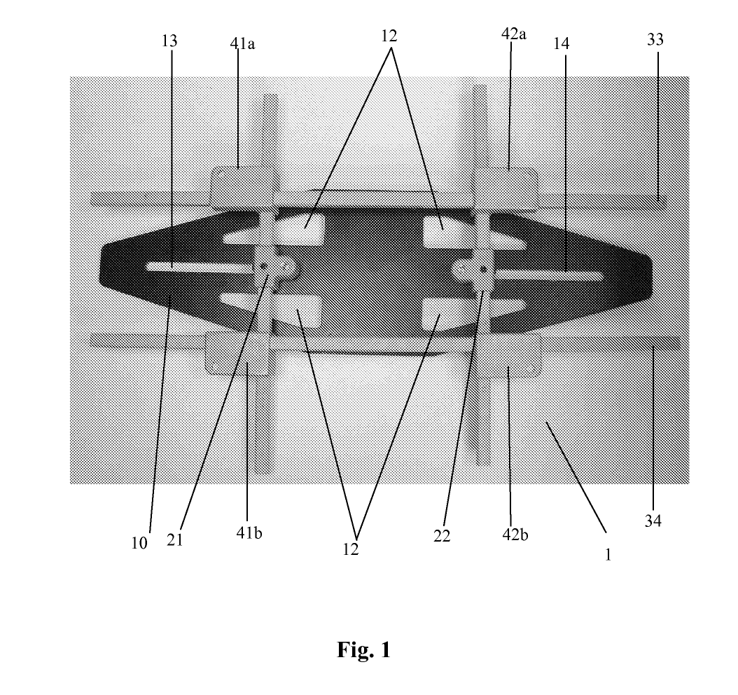

FIG. 1 is a VDU-side plan view of a preferred embodiment of the present invention in a reduced-size or minimum configuration;

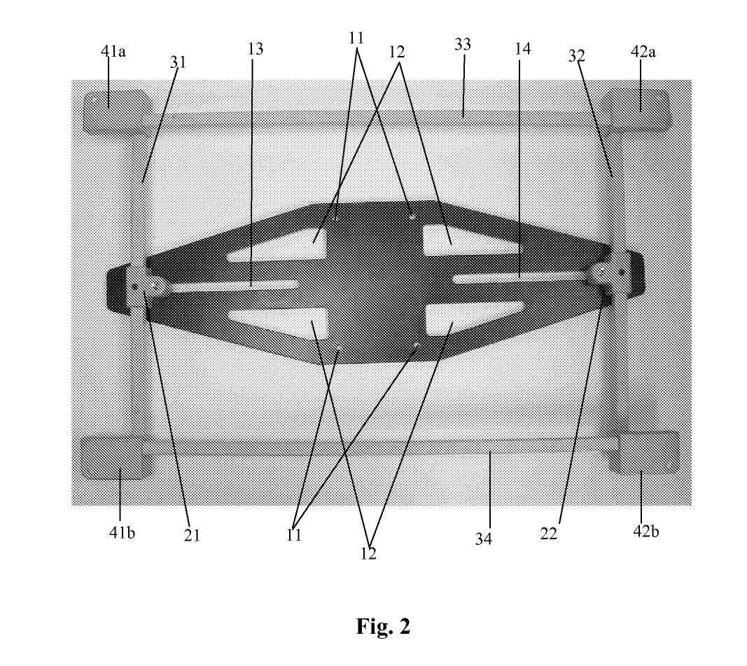

FIG. 2 is a VDU-side plan view of a preferred embodiment of the present invention in an enlarged size or extended configuration;

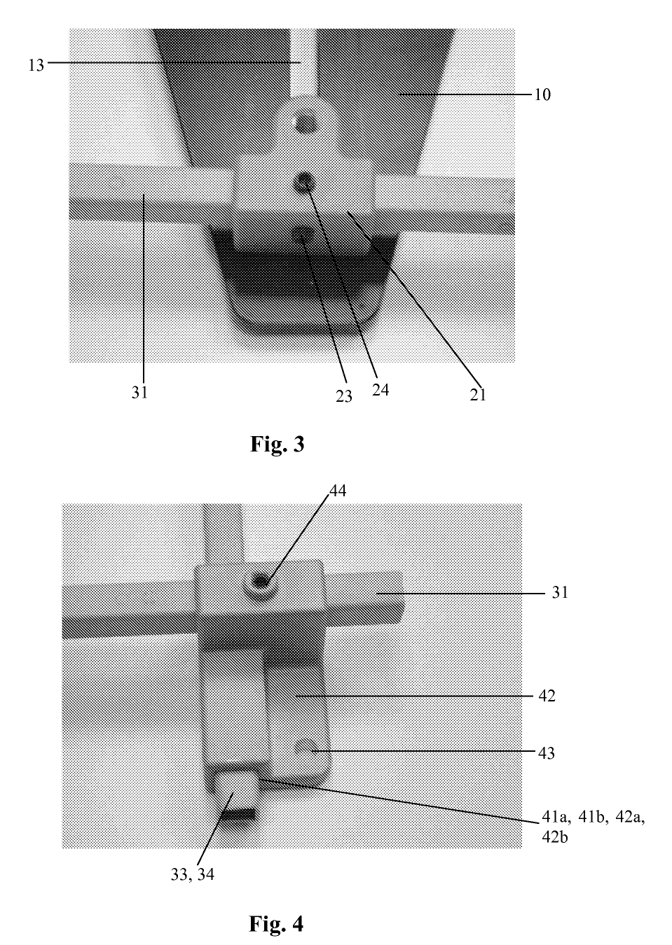

FIG. 3 is a VDU-side perspective view of a connector supporting a vertical support member from a support mounting member;

FIG. 4 is support-side perspective view of a VDU mounting member having vertical and horizontal support members moveably arranged there-through; and

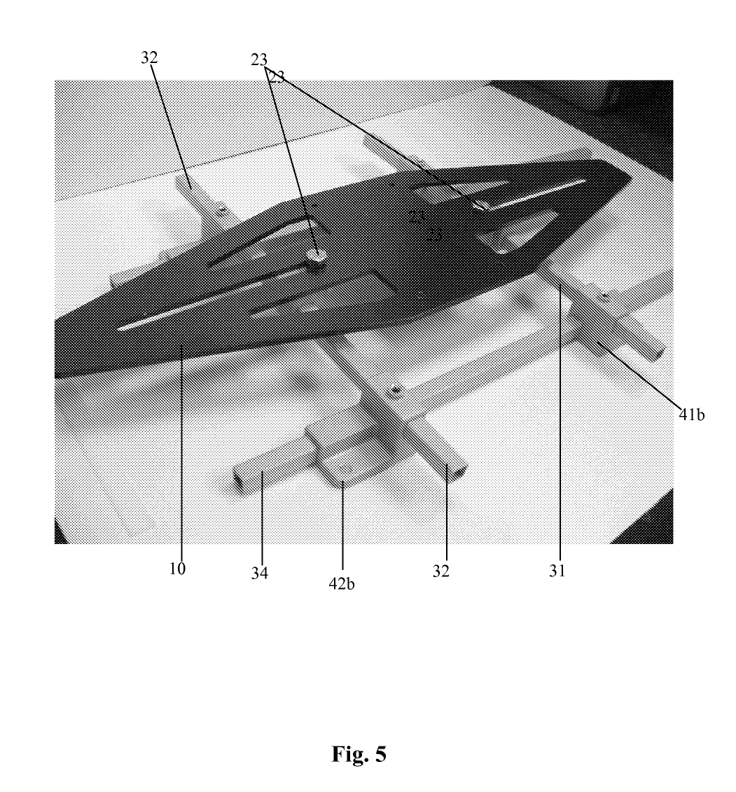

FIG. 5 is a support-side perspective view of the preferred embodiment of the present invention;

The following section provides a definition of terms used in describing the present invention.

A visual display unit (VDU) is taken to mean any electronic display apparatus capable of displaying an electronic image, such as a television, video or computer monitor. The preferred embodiment of the present invention is adapted to support, in particular, a flat-panel VDU, such as a plasma, TFT or LCD VDU, or any similar future technology.

It is common for many VDUs to have a “wide-screen” aspect ratio. The preferred embodiment of present invention is adapted for supporting a wide-screen VDU in a landscape orientation having a larger horizontal than vertical axis.

FIGS. 1 and 2 show a VDU-side view of a mounting apparatus. In this sense, VDU-side means the view from a side of apparatus onto which a VDU is mountable. Similarly, FIG. 5 shows a support-side view, which is taken from a side of the apparatus suitable for affixing to a support structure.

The apparatus 1 in FIG. 1 is arranged in a minimum or small configuration suitable for attachment to a VDU having a relatively small distance between mounting points, whereas FIG. 2 shows an extended or large configuration of the apparatus 1, which is suitable for attachment to a VDU having a relatively large distance between mounting points.

The preferred embodiment 1 comprises a mounting member 10 which is adapted to be attached to a support structure, such as a wall or free-standing structure, such as a stand. The mounting member 10 is substantially planar, having a polygonal outer periphery, generally in the form of a diamond. The mounting member 10 has a longer horizontal than vertical axis. The mounting member thus has an aspect ration similar to a landscape VDU. It will be realised that other configurations of mounting member are possible, such as other shapes, for example, square, rectangular or cross-shaped.

The mounting member 10 is of unitary integral construction and comprises a plurality of apertures 11 there-through for accepting retaining means such as screws or bolts to be secured into, and retained by, the support structure. The mounting member 10 is attached onto a support structure such that a support-side face of the mounting member 10 (shown in FIG. 5) is coextensive with a surface of the structure. In order to reduce a weight of the mounting member 10, which is made of metal or other suitable material, a plurality of apertures 12 are provided.

The mounting member 10 comprises a pair of elongate mounting slots or apertures 13, 14 arranged in sequential axial-alignment centrally along a central axis of the mounting member 10.

A pair of connectors 21, 22 is moveably mounted upon the mounting member 10. The connectors 21, 22 are slideably mounted through the mounting slots 13, 14, such that each connector 21, 22 is moveable along the respective mounting slot 13, 14. Each connector 21, 22 comprises a threaded aperture into which a bolt 23 is inserted from the support side of the mounting member 10 to clamp the mounting member 10 between a head of the bolt 23 and the support side face of the connector 21, 22 when suitably tightened. When released slightly, each connector 21, 22 is retained within the corresponding mounting slot 13, 14 whilst being allowed to slide there-along. A horizontal position of each connector 21, 22 can be set by a user before the bolts 23 are tightened such that the connectors 21, 22 remain in a fixed horizontal position relative to the mounting member 10.

Each connector 21, 22 comprises a vertically oriented aperture there-through, through which a vertical support member 31, 32 is arranged in a corresponding vertical orientation. Each aperture has a square cross section, to accept a square support member 31, 32. The support members 31, 32 are slideably mounted through each corresponding connector 21, 22, such that a vertical position of each support member 31, 32 can be altered in relation to its corresponding connector 21, 22 and the mounting member 10. In this way, the horizontal position of each connector 21, 22 and vertical position of each support member 31, 32 can be adjusted relative to the mounting member 10.

As shown in FIG. 3, threaded apertures are arranged in perpendicular sides of each connector 21, 22 to intersect the aperture through which the support member 31, 32 is arranged. A threaded grub-screw 23, 24 is inserted into each threaded aperture in order to grip the support member 31, 32 when suitably tightened. In this way, the vertical position of each vertical support member 31, 32 can be fixed after suitable adjustment by a user for a desired VDU.

Upon each vertical support member 31, 32 a pair of VDU mounting members 41a, 41b, 42a, 42b are slideably mounted. Each VDU mounting member 41a, 41b, 42a, 42b can be moved along the respective vertical support member 31, 32 in a vertical, or upward and downward direction. A pair of VDU mounting members 41a, 41b or 42a, 42b are mounted either side of the corresponding connector 21, 22 upon the support member.

FIG. 4 shows a support side of a VDU mounting member 41, 41b, 42a, 42b. Each VDU mounting member 41a, 41b, 42a, 42b comprises a substantially planar surface 42 for contacting coextensively against a rear of a VDU, the surface having an aperture 43 for receiving a fastener to engage with a mounting point at a rear of a VDU, such that the VDU is retained upon the mounting member 41a, 41b, 42a, 42b, as will be explained later.

Further, each VDU mounting member 41a, 41b, 42a, 42b comprises a vertically oriented aperture there-through for receiving a respective vertical support member 31, 32. Intersecting the aperture arranged to receive the support member 31, 32 is a threaded aperture arranged to receive a threaded grub screw 44. Similar to the connectors 21, 22 the grub screw is used to grip the vertical support member 31, 32 and fix a relative vertical position of the VDU mounting member 41, 41b, 42a, 42b relative to the support member 31, 32 and, consequently, the mounting member 10. The grub screw 44 can be released by a user such that the VDU mounting member 41, 41b, 42a, 42b can be vertically moved suitable for a desired VDU.

Each VDU mounting member 41a, 41b, 42a, 42b further comprises a horizontally oriented aperture there-through, which is offset from the vertically oriented aperture so that the two do not interfere. Through the horizontal aperture in each VDU mounting member 41a, 41b, 42a, 42b, a horizontal support member 33, 34 is slideably located in a horizontal orientation.

Each VDU mounting member 41a, 41b, 42a, 42b comprises a means for mounting a VDU thereto. Typically, each VDU mounting member 41a, 41b, 42a, 42b comprises an aperture oriented perpendicular to the orientation of the mounting member 10. This allows a fastener, such as a bolt to be inserted through the VDU mounting member 41a, 41b, 42a, 42b and into a mounting point on a rear of the VDU. Once mounted, the VDU is suspended by the VDU mounting members 41a, 41b, 42a, 42b upon the support members 31, 32, 33, 34 and mounting member 10 which is affixed to a support structure.

The above-described moveable configuration of the mounting member 10, the connectors 21, 22, vertical 31, 32 and horizontal support members 41, 42, and VDU mounting members 41a, 41b, 42a, 42b allows the relative location of VDU mounting members 41a, 41b, 42a, 42b to be adjusted to receive a wide variety of VDU. A single apparatus can be used to suspend different VDU should replacement be required or a single apparatus can be purchased for a variety of VDU.

As shown in FIG. 1, by sliding the connectors 21, 22 toward a centre of the mounting member 10, the relative horizontal separation of the VDU mounting members 41a, 41b, 42a, 42b can be reduced. As the connectors 21, 22 are slid toward a centre of the mounting member 10, the horizontal support members 33, 34 are slid through the VDU mounting members 41a, 41b, 42a, 42b in a corresponding manner. In order to reduce a vertical separation of the VDU mounting members 41a, 41b, 42a, 42b, the each pair 41a, 42a, and/or 41b, 42b is slid toward a centre of the vertical support members 31, 32 such that the vertical separation is reduced. Comparison of FIGS. 1 and 2 shows the adjustment of the apparatus for differently sized VDU or VDU having differently spaced mounting points.

In use, when a VDU is mounted upon the apparatus, the VDU exerts a downward, vertical, force through the vertical support members 31, 32 to the connectors 21, 22, the mounting member 10 and support structure. The weight of the VDU is not substantially taken by any suspended horizontal member, which advantageously, allows more weight to be supported, typically in the form of a larger VDU. The horizontal support members 33,34 prevent movement of the vertical support members without being subjected to a substantial bending or turning movement.

The present invention provides a mounting apparatus for a VDU which can be easily adapted to mount thereon VDUs of different sizes or different mounting point centers.

Although a preferred embodiment has been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-14. (canceled)

15. An apparatus for mounting a visual display unit (VDU) upon a structure, comprising:
a support mounting member for attaching to a structure;
a pair of first support member moveably mounted upon the mounting member respectively by a pair of connectors in a first direction relative to the support mounting member which is substantially horizontal in use; and
a pair of VDU mounts for mounting a VDU thereon, each VDU mount being moveably mounted upon a respective one of the pair of first support members to be moveable in a second direction relative to the support mounting member which is substantially perpendicular to the first direction and which is substantially vertical in use;
characterized by:
a second support member moveably mounted on the pair of first support members and linking the pair of VDU mounts so that movement of the second support member in the second direction causes an equivalent movement in each VDU mount.

16. The apparatus of claim 15 wherein each support member is generally elongate.

17. The apparatus of claim 15, wherein the position of each first support member relative to the support mounting member is fixedly adjustable by a user.

18. The apparatus of claim 15, wherein each first support member is slideably mounted upon the support mounting member within an elongate mounting slot.

19. The apparatus of claim 18, wherein each support member is slideably mounted upon the support mounting member within an individual elongate mounting slot.

20. The apparatus of claim 15, wherein the connector is slideably arranged within the mounting slot.

21. The apparatus of claim 20, wherein each connector comprises a generally vertically oriented aperture within which each respective first support member is moveably mounted.

22. The apparatus of claim 20, wherein each connector comprises releasable gripping means for gripping each respective first support member, such that a relative position of each first support member and the connector may be adjusted by a user.

23. The apparatus of claim 15, wherein the position of each pair of VDU mounts relative to each respective support member may be fixedly adjusted by a user.

24. The apparatus of claim 15, wherein each VDU mount comprises a first aperture there-through and each respective first support member is arranged through the aperture, such that each VDU mount is slidable in relation to each respective first support member

25. The apparatus of claim 24, wherein each VDU mount comprises a second aperture having the second support member arranged there-through such that each of the pair of first support members the second support member intersect at respective VDU mounts.

26. The apparatus of claim 15, wherein each VDU mount comprises releasable gripping means for gripping each respective first support member, such that a relative position of each VDU mount and each support member may be fixedly adjusted by a user.

27. The apparatus of claim 15, wherein the support mounting member is substantially planar.

28. The apparatus of claim 15, wherein there are two second support members and two corresponding pairs of VDU mounts.
